(19) United States
(12) Patent Application Publication
(10) Pub. No.: US 2009/0145207 A1
(43) Pub. Date: Jun. 11, 2009

(54) DEVICE AND METHOD FOR CHARACTERIZING A VARIATION OF STRUCTURE OF A CONTINUOUS PHASE DURING FLOW

(76) Inventors: Mosto Bousmina, Ste-Foy (CA); Nizar Mechbal, Quebec (CA); Sebastien Gagne, Levis (CA)

Correspondence Address: FAY KAPLUN & MARCIN, LLP, 150 BROADWAY, SUITE 702, NEW YORK, NY, 10038, US

(21) Appl. No.: 12/067,527

(22) PCT Filed: Sep. 20, 2006
(86) PCT No.: PCT/CA2006/001550

§ 371 Date: Jan. 12, 2009

Related U.S. Application Data
(60) Provisional application No. 60/718,310, filed on Sep. 20, 2005.

(51) Int. Cl. G01N 21/17

(52) U.S. Cl. 73/61.61

(57) ABSTRACT

A device includes a first rotating cylinder embedded within a second rotating cylinder. The two cylinders define a gap therebetween for containing the continuous phase, wherein the continuous phase is submitted to the relative rotation movement of the two cylinders thus creating a flow in the continuous phase. The variation of structure of the continuous phase is visualized and characterized through optical means such as high speed cameras, laser sources, laser optics and lenses.

### FIELD OF THE INVENTION

The present invention is concerned with in situ visualization and optical characterization of the structure evolution of a continuous phase under flow. More specifically, but not exclusively, the present invention is concerned with a device and method to visualize and to probe the structure variation of drops and particles of a continuous phase submitted to flow stress, such as shear flow and elongational flow.

### BACKGROUND OF THE INVENTION

Blending of existing polymers is an appealing way for producing new polymeric materials, the performance of which can be customized to specific applications. This method is all the more interesting as it is generally economic. A major characteristic of multiphase blends is that they potentially preserve certain key properties of the original constituent polymers. Attainment of satisfactory mechanical or other properties of a blend is dependent on a constituent polymer existing as a finely dispersed phase, also known as continuous phase, within the blend as a whole and on the stability of the structure of the blend during subsequent processing.

Continuous phase polymeric materials are, for example, emulsions, suspensions and dispersions. They appear in a wide range of applications and, as such, techniques and pertaining instrumentation to determine mechanical and other properties thereof are advantageously developed.

The use of multiphase polymeric blends for designing polymer blends showing new or unexpected properties, whether micro- or nanostructured multiphase polymer blends, can be of particular interest in blends such as thermosets, thermoplastics, thermoplastic vulcanizates and structured copolymers. For instance, such new or unexpected properties can be concerned with adhesion of polymer-polymer interfaces in immiscible polymer blends, formation of nanostructures in thermosetting polymers, crystallization behavior in confined-morphology blends, plasticity, elasticity and shear deformation.

When it comes to change the properties of a material, for instance such as its resistance or its conductivity, the behavior of the material being in a molten state during the manufacturing process must be understood. Thus, it is desirable to comprehend how the molten material flows and how a modification of the flow thereof changes the final properties of the material.

On this subject, rheology studies the deformation and flow of matter under the influence of an applied stress, and in particular elasticity and fluid mechanics of materials, the mechanical behaviour of which cannot be described with the classical theories. Rheology is also concerned with establishing predictions for mechanical behaviour (on the continuum mechanical scale) based on the micro- or nanostructure of the material, e.g. the molecular size and architecture of polymers in solution or the particle size distribution in a solid suspension.

Thus, the present invention is concerned with a new and improved device and method usable to test and comprehend the behavior of molten material flows and how a modification of that flow changes the final properties of the material.

### SUMMARY OF THE INVENTION

According to a first aspect of the present invention, there is provided a method for characterizing a variation of structure of a continuous phase, comprising: providing a first body comprising a wall; providing a second body comprising a surface; defining between the wall of the first body and the surface of the second body a gap for containing the continuous phase; inducing a relative movement of the first and second bodies in order to submit the continuous phase to the relative movement of the first and second body and produce a flow in the continuous phase; and determining an optical property of the continuous phase under flow to characterize a variation of structure of said continuous phase.

According to a second aspect of the present invention, there is provided a method for characterizing a variation of structure of a continuous phase, comprising: providing an outer cylinder coaxial with a rotation axis, the outer cylinder comprising one end provided with a hollow cavity coaxial with the rotation axis, the hollow cavity being formed with a bottom wall and a lateral wall; providing an inner cylinder coaxial with the rotation axis, the inner cylinder being disposed in the hollow cavity and having a lateral surface and a bottom surface; defining a gap for containing the continuous phase, the gap being defined between (i) the combination of the bottom and lateral walls, and (ii) the combination of the bottom and lateral surfaces; inducing a relative rotational movement of the inner and outer cylinders in order to submit the continuous phase to the relative rotational movement of the inner and outer cylinders and produce a flow in the continuous phase; and determining an optical property of the continuous phase under flow to characterize a variation of structure of the continuous phase.

According to a third aspect of the present invention, there is provided a device for characterizing a variation of structure of a continuous phase, comprising: a first body comprising a wall; a second body comprising a surface; a gap for containing the continuous phase, the gap being defined between the wall of the first body and the surface of the second body; a mechanism for inducing a relative movement of the first and second bodies in order to submit the continuous phase to the relative movement of the first and second body and produce a flow in the continuous phase; and an optical characterizer responsive to an optical property of the continuous phase under flow to determine a variation of structure of said continuous phase.

According to a fourth aspect of the present invention, there is provided a device for characterizing a variation of structure of a continuous phase, comprising: a rotation axis; an outer cylinder coaxial with the rotation axis, the outer cylinder comprising one end provided with a hollow cavity coaxial with the rotation axis, the hollow cavity being formed with a bottom wall and a lateral wall; an inner cylinder coaxial with the rotation axis, the inner cylinder being disposed in the hollow cavity and having a lateral surface and a bottom surface; a gap for containing the continuous phase, the gap being defined between (i) the combination of the bottom and lateral walls, and (ii) the combination of the bottom and lateral surfaces; a rotating mechanism for inducing a relative rotational movement of the inner and outer cylinders in order to submit the continuous phase to the relative rotational movement of the inner and outer cylinders and produce a flow in the continuous phase; and an optical characterizer responsive to an optical property of the continuous phase under flow to determine a variation of structure of the continuous phase.

The foregoing and other objects, advantages and features of the present invention will become more apparent upon reading of the following non-restrictive description of illustrative embodiments thereof, given by way of example only, with reference to the accompanying drawings.

### BRIEF DESCRIPTION OF THE DRAWINGS

In the appended drawings:

FIG. 1 is a cross sectional, side elevational view of a non-restrictive, illustrative embodiment of the device for characterizing a variation of structure of a continuous phase according to the present invention;

FIG. 2 is a schematic block diagram of an optical characterizer of the device for characterizing a variation of structure of a continuous phase of FIG. 1;

FIG. 3a is a side elevational view of an inner cylinder of the device for characterizing a variation of structure of a continuous phase of FIG. 1, comprising a drive shaft; and

FIG. 3b is a perspective view of the inner cylinder of FIG. 3a, with its drive shaft.

### DETAILED DESCRIPTION

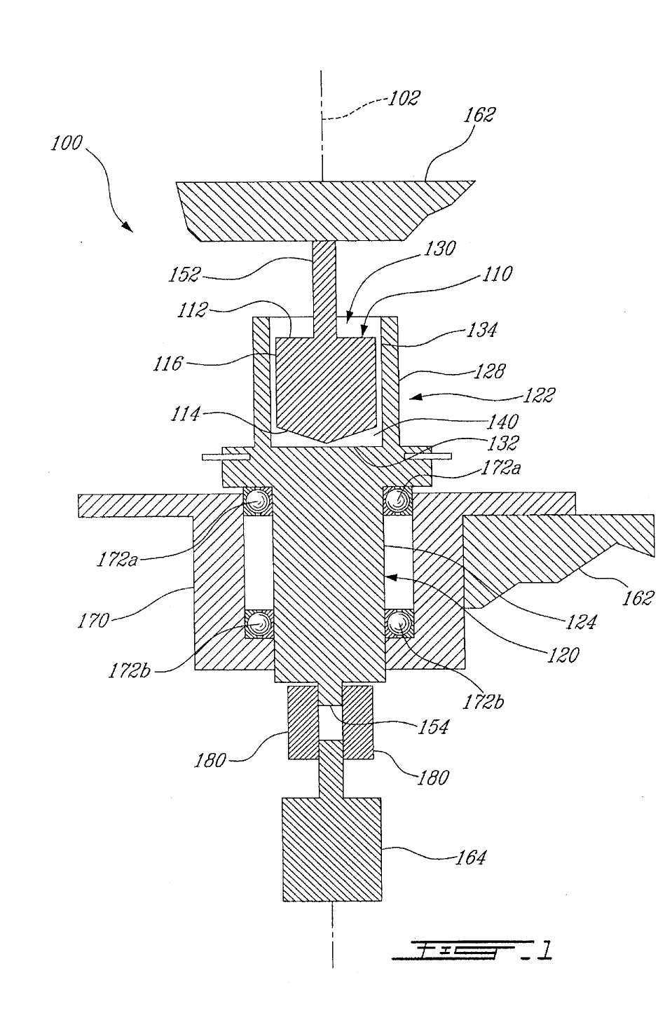

In the following description, a non-restrictive, illustrative embodiment of the device and method for characterizing a variation of structure of a continuous phase according to the present invention will be described with reference to FIGS. 1, 2, 3a and 3b of the appended drawings. More specifically, the non-restrictive, illustrative embodiment is concerned with characterization of a variation of structure, for example the morphology, of a continuous phase disposed in a gap defined by two surfaces moving relative to each other, wherein the continuous phase is probed by an optical system while it is submitted to a flow generated by the relative movement of the two surfaces.

The flow produced by the relative movement of the two surfaces can be a shear flow, an elongational flow or any other type of flow and the variation of structure of the continuous phase can be, for example, a deformation, rupture, coalescence or combinations thereof of drops or particles taking place in emulsions, suspensions, dispersions or combinations thereof under flow.

Characterization of the variation of structure of the continuous phase involves optical properties of the continuous phase such as, for example, birefringence, dichroism, light scattering, etc.

FIG. 1 is a schematic diagram of a device 100 for characterizing a variation of structure of a continuous phase according to the non-restrictive, illustrative embodiment of the present invention.

Referring to FIG. 1, the characterizing device 100 has a rotation axis 102, an inner cylinder 110 and an outer cylinder 120.

The outer cylinder 120 is mounted coaxial to and rotative about the rotation axis 102. The outer cylinder 120 comprises a cylindrical body 124 and an end portion 122 formed with a cylindrical, hollow cavity 130 coaxial to the rotation axis 102. The cylindrical, hollow cavity 130 is formed with a bottom, generally flat wall 132 and a lateral, generally cylindrical wall 134.

The cylindrical, hollow cavity 130 is structured and dimensioned to accommodate the inner cylinder 110. This inner cylinder 110 is mounted in the cylindrical, hollow cavity 130 coaxial to and rotative about the rotation axis 102. This inner cylinder 110 comprises a distal, generally flat surface 112, a bottom, generally conical surface 114 confronting the bottom wall 132 of the cavity 130 and a lateral, generally cylindrical surface 116 confronting the lateral wall 134 of the cavity 130.

The bottom surface 114 of the inner cylinder 110 and the bottom wall 132 of the cavity 130 are spaced apart from each other, and the lateral surface 116 of the inner cylinder 110 and the lateral wall 134 of the cavity 130 are also spaced apart from each other to define therebetween a gap 140 designed to produce the desired flow of the continuous phase. In fact, the gap 140 defined between (i) the bottom wall 132 and the lateral wall 134 of the cavity 130 and (ii) the bottom surface 114 and the lateral surface 116 of the inner cylinder 110 receives the continuous phase of which a variation of structure is to be characterized.

In the non-restrictive, illustrative embodiment of FIG. 1, the bottom surface 114 has a convex, generally conic surface whereas the bottom wall 132 is generally flat. However, it is within the scope of the present invention to use other shapes of bottom surface 114 and wall 132 depending on the type of flow to be generated. For example, the bottom surface 114/bottom wall 132 combination can be, for example, a flat/flat combination, a conic/conic combination, a bob/cup combination, etc.

A first drive shaft 152 is coupled, at one end, to the distal, generally flat surface 112 of the inner cylinder 110 and, at the other end, to a rheometer 162. In operation, the rheometer 162 will rotate the inner cylinder 110 about the rotation axis 102 in a first angular direction.

A second drive shaft 154 is coupled, at one end, to the end of the cylindrical body 124 of the outer cylinder 120 opposite to the cavity 130 and, at the other end, to a driving unit 164, for example an electric motor with gearhead. In operation, the driving unit 164 will rotate the outer cylinder 120 about the rotation axis 102 in a second angular direction.

Alternatively, it is possible to couple drive shaft 152 to an electric motor/gearhead assembly and drive shaft 154 to a rheometer.

In operation, the inner 110 and outer 120 cylinders are rotated relative to one another about the rotation axis 102, either in the same angular direction or in opposite angular directions, i.e. clockwise/counter-clockwise, at the required angular velocities. It is also within the scope of the present invention to rotate only one of the inner 110 and outer 120 cylinders about the rotation axis 102. The relative rotating movement induced on the inner cylinder 110 and the outer cylinder 120 by the rheometer 162 and the driving unit 164 creates a flow within the continuous phase, for example a shearing flow or an elongational flow.

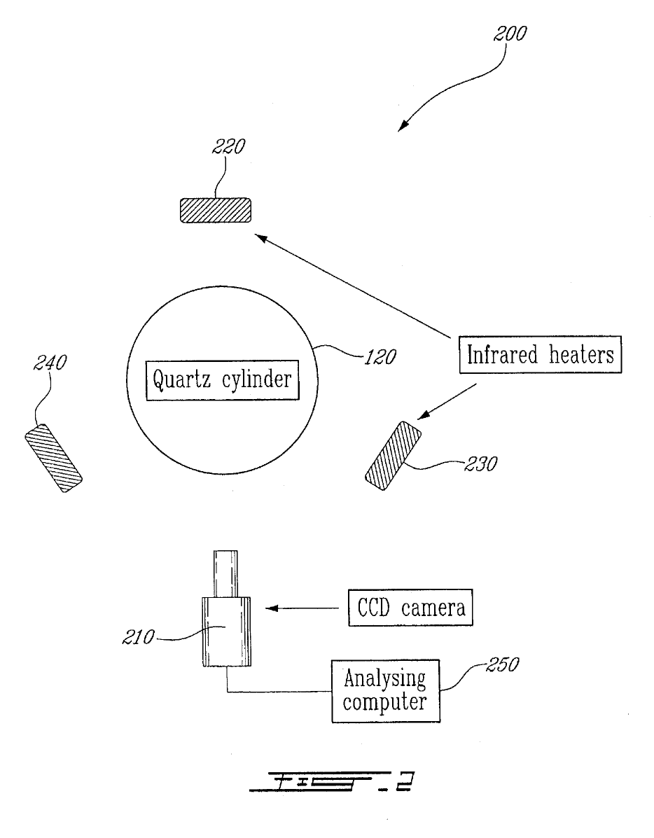

The continuous phase to be characterized can be, for example, molten polymers, molten immiscible polymers, emulsions and suspensions, etc. Of particular interest is the case wherein the inner 110 and outer 120 cylinders are rotated at the same angular velocity but in opposite angular directions, such that the object of analysis, such as drops or particles (isotropic or anisotropic) is fixed in space in the continuous phase whereby the variation of the structure of this continuous phase can be detected by means of laser-based optics or with one or many CCD cameras (FIG. 2). The variation of structure of the continuous phase may comprise, as mentioned in the foregoing description, a deformation of drops of the continuous phase, a rupture of drops of the continuous phase, a coalescence of drops of the continuous phase and combinations thereof.

The rheometer 162 can be, for example, model MCR-500 from Anton Paar Physica. In the non-restrictive illustrative embodiment, the driving unit 164 is an electrical motor, for example Baldor BSM50N-133AA, coupled to the drive shaft 154 through a gearhead, for example Carson Gearhead 23EPO40. The rotation parameters of the motor, such as velocity profile, are controlled, for example, by means of a drive, for example Baldor FlexDrive FDH1A02TB-RN20, that allows for adaptation of the motor rotation to the specific application. The above mentioned electrical motor of the driving unit 164 may also be equipped with a torquemeter and a displacement sensor that allow independent measurements of torques, stresses and deformations.

As illustrated in FIG. 1, the cylindrical body 124 of the outer cylinder 120 is rotatively mounted about the rotation axis 102 on an alignment guide 170 through a pair of ball bearings 172a and 172b. The function of the alignment guide 170 is to avoid possible misalignment between the driving unit 164 and the rheometer 162. In the non-restrictive illustrative embodiment, the outer cylinder 120 is guided by means of an aluminum alignment guide 170 that is fixed on the main body of the rheometer 162 by using the same fixing mechanism that is used for conventional coaxial cylinders by Physica MCR 500. The drive shaft 154 of the outer cylinder 120 is coupled to the driving unit 164 through a flexible coupling 180 provided to avoid eventual torsion that may arise during operation of the non-restrictive, illustrative embodiment of the device 100 for characterizing a variation of structure of a continuous phase.

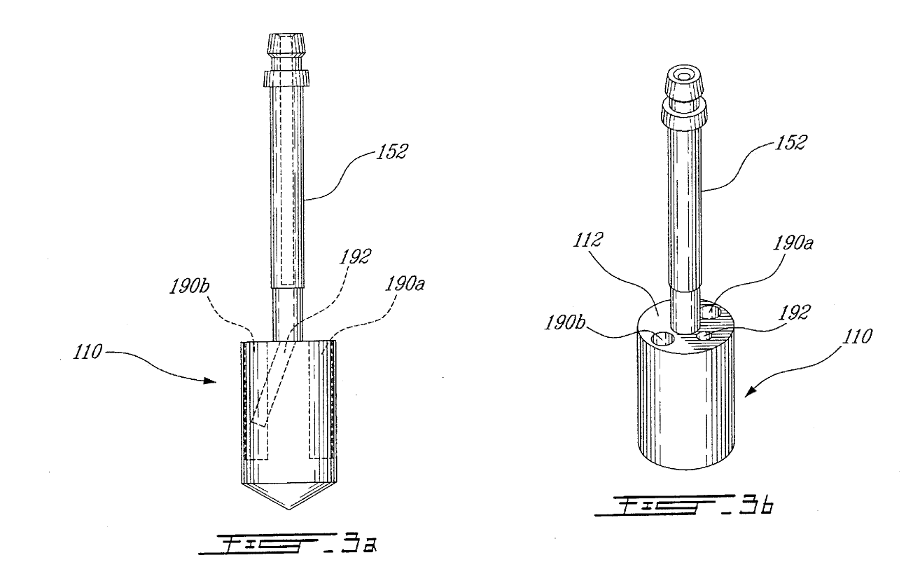

Referring now to FIG. 3, the distal, generally flat surface 112 of the inner cylinder 110 comprises two cylindrical holes 190a and 190b for receiving and containing two cartridge heaters (not shown), for example of the type CSH-101100/120 from Omega. The cartridge heaters are meant to ensure a constant temperature within the continuous phase. The two holes 190a and 190b extend parallel to the rotation axis 102 and are diametrically opposite with respect to that rotation axis. A third hole 192 is also drilled through the distal, generally flat surface 112 and is meant for accommodating a thermocouple (not shown), for example of the type DH-1-20-K-12 from Omega for probing the temperature of the continuous phase. The third hole 192 is drilled with a predetermined angle allowing the thermocouple to be as close as possible to the lateral, cylindrical surface 116 (FIG. 1) of the inner cylinder 110. The cartride heaters and the thermocouple work in combination for controlling the temperature of the continuous phase in the gap 140. An additional external heating system consisting, for example, of thermal-radiation heating such as infrared heaters 220, 230 and 240 (FIG. 2) can also be dispose around the measuring cell (inner cylinder 110, outer cylinder 120 and gap 140) to ensure an homogeneous temperature within the continuous phase. Depending on the temperature and the application, the measuring cell (inner cylinder 110, outer cylinder 120 and gap 140) may be made of transparent plastic, regular glass, quartz or any other transparent material.

A rheometer supporting table (not shown) is provided as an anti-vibration workstation. This rheometer supporting table includes a hole therein to enable the connection between the assembly electric motor/gearhead of the driving unit 164 and the measuring cell (inner cylinder 110, outer cylinder 120 and gap 140). The assembly electric motor/gearhead of the driving unit 164 is mounted to a base (not shown), made for example of aluminum and including fastener-receiving apertures to secure that base to the rheometer supporting table through threaded rods and nuts.

FIG. 2 is a schematic block diagram of an example of optical characterizer 200 responsive to an optical property of the continuous phase. FIG. 2 schematically illustrates the outer cylinder 120, made of optically transparent quartz in this particular example, the three infrared heaters 220, 230 and 240, a camera 210 and an analyzing computer 250.

The optical characterizer 200 may comprise, in the example of FIG. 2, one or many high-speed cameras 210, such as CCD high-speed cameras combined as required with laser-based optics, laser-based sources and detectors, lenses, rheo-optics, etc. For example, the choice of the lenses will depend on the dimensions of the objects, such as drops or particles (isotropic or anisotropic), under investigation. Since the measuring cell including the outer cylinder 120 may be made of transparent plastic, regular glass, quartz or any other optically transparent material, the continuous phase under consideration can be examined by a high speed CCD camera or cameras through the transparent material of the outer cylinder 120 by positioning the CCD camera radially about the rotation axis 120 in order to aim toward the continuous phase.

CCD cameras use a solid state image-sensing element called “charge-coupled device”. More specifically, CCD cameras comprise an array of silicon sensors capable of aligning each pixel sensor much more accurately than can conventional vidicon image sensors. This positional accuracy reduces geometric distortion. Also, light impulses can be used to make possible the taking of a picture of a body moving at high speed.

An analyzing computer 250, connected to the CCD camera(s) such as 210 can analyze the image(s) from the CCD camera(s) to characterize an optical property of the continuous phase. Characterizing an optical property of the continuous phase makes it possible to deduce another underlying property, such as a mechanical property, an electrical property, etc., related to this optical property.

The CCD camera(s) 210 can be mounted on an XYZ precision support (not shown), for example of the type Opto Sigma. This support is itself mounted on a circular rail (not shown) coaxial with the rotation axis around the measuring cell (inner cylinder 110, outer cylinder 120 and gap 140) to enable movement of the CCD camera(s) along that rail without loosing the focus.

Finally, the non-restrictive, illustrative embodiment of the device and method for vcharacterizing a variation of structure of a continuous phase according to the present invention can be computer-controlled, for instance by using Labview software or other computer controlling means.

Although the present invention has been described hereinabove by way of a non-restrictive, illustrative embodiment, this embodiment can be modified at will, within the scope of the appended claims, without departing from the spirit and nature of the subject invention.

1.-29. (canceled)

30. A device for characterizing a variation of structure of a continuous phase, comprising:
a rotation axis;
an outer cylinder coaxial with the rotation axis, the outer cylinder comprising a hollow cavity coaxial with the rotation axis, the hollow cavity being formed with a lateral wall;
an inner cylinder coaxial with the rotation axis, the inner cylinder being disposed in the hollow cavity and having a lateral surface;
a gap for containing the continuous phase, the gap being defined between the lateral wall and the lateral surface;
a rotating mechanism for inducing a relative rotational movement of the inner and outer cylinders in order to submit the continuous phase to the relative rotational movement of the inner and outer cylinders and produce a flow in the continuous phase; and
an optical characterizer responsive to an optical property of the continuous phase under flow to determine a variation of structure of said continuous phase;
wherein the rotating mechanism comprises a first driving unit coupled to the inner cylinder so as to rotate the inner cylinder about the rotation axis and a second driving unit coupled to the outer cylinder so as to rotate the outer cylinder about the rotation axis, whereby the first and second driving units can rotate the inner and outer cylinders with respective individual angular directions and velocities.

31. A device as recited in claim 30, wherein the optical characterizer comprises a camera.

32. A device as recited in claim 31, wherein the camera is a high speed CCD camera.

33. A device as recited in claim 31, wherein the optical characterizer further comprises at least one of the following optical elements: a lens, laser-based optics and rheo-optics.

34. A device as recited in claim 31, wherein at least the outer cylinder is made of transparent material to enable said camera to detect said optical property through said transparent outer cylinder.

35. A device as recited in claim 31, further comprising:
a circular rail coaxial with the rotation axis, wherein the camera is mounted on the rail for movement of the camera along the rail.

36. A device as recited in claim 31, wherein the first driving unit comprises a rheometer for rotating the inner cylinder about the rotation axis.

37. A device as recited in claim 31, wherein the continuous phase is a substance selected from the group consisting of an emulsion, a suspension, a dispersion and combinations thereof.

38. A device as recited in claim 31, wherein the inner cylinder comprises a heating source.

39. A device as recited in claim 38, wherein the heating source comprises at least one cartridge heater embedded in the inner cylinder.

40. A device as recited in claim 31, wherein the inner cylinder comprises a temperature sensor embedded therein.

41. A device as recited in claim 31, comprising an external thermal-radiation heating source.

42. A device as recited in claim 41, wherein the external thermal-radiation heating source comprises an infrared source.

43. A device as recited in claim 31, wherein the variation of structure comprises a structure variation selected from the group consisting of a deformation of drops of the continuous phase, a rupture of drops of the continuous phase, a coalescence of drops of the continuous phase and combinations thereof.

44. A device as recited in claim 32, wherein the optical characterizer comprises an analyzing computer to analyze images from the camera in view of determining said optical property and thereby said variation of structure.

45. A device as recited in claim 31, wherein the hollow cavity comprises a bottom wall, the inner cylinder comprises a bottom surface and the gap extends between the bottom surface and the bottom wall.

46. A device as recited in claim 45, wherein the bottom surface and wall have complementary shapes.

47. A device as recited in claim 46, wherein the bottom surface and wall have different shapes.

48. A device as recited in claim 30, comprising a flexible coupling interposed between the second driving unit and the outer cylinder.

49. A device as recited in claim 30, wherein the first and second driving units of the rotating mechanism rotate the inner and outer cylinders about the rotation axis in respective opposite angular directions.

50. A device for characterizing a variation of structure of a continuous phase, comprising:
a first body comprising a wall;
a second body comprising a surface;
a gap for containing the continuous phase, the gap being defined between the wall of the first body and the surface of the second body;
a mechanism for inducing a relative movement of the first and second bodies in order to submit the continuous phase to the relative movement of the first and second bodies and produce a flow in the continuous phase; and
an optical characterizer responsive to an optical property of the continuous phase under flow to determine a variation of structure of said continuous phase;
wherein the mechanism comprises a first driving unit coupled to the first body so as to move the first body and a second driving unit coupled to the second body so as to move the second body, whereby the first and second driving units can move the first and second bodies with respective individual directions and velocities.

51. A method for characterizing a variation of structure of a continuous phase, comprising:
providing a first body comprising a wall;
providing a second body comprising a surface;
defining between the wall of the first body and the surface of the second body a gap for containing the continuous phase;
inducing a relative movement of the first and second bodies in order to submit the continuous phase to the relative movement of the first and second body and produce a flow in the continuous phase; and
determining an optical property of the continuous phase under flow to characterize a variation of structure of said continuous phase;
wherein inducing a relative movement comprises moving the first body through a first driving unit and moving the second body through a second driving unit, whereby the first and second driving units can move the first and second bodies in respective individual directions and velocities.

52. A method for characterizing a variation of structure of a continuous phase, comprising:
providing an outer cylinder coaxial with a rotation axis, the outer cylinder comprising a hollow cavity coaxial with the rotation axis, the hollow cavity being formed with a lateral wall;
providing an inner cylinder coaxial with the rotation axis, the inner cylinder being disposed in the hollow cavity and having a lateral surface;
defining a gap for containing the continuous phase, the gap being defined between the lateral wall and the lateral surface;
inducing a relative rotational movement of the inner and outer cylinders in order to submit the continuous phase to the relative rotational movement of the inner and outer cylinders and produce a flow in the continuous phase; and
determining an optical property of the continuous phase under flow to characterize a variation of structure of said continuous phase;
wherein inducing a relative rotational movement comprises rotating the first cylinder about the rotation axis through a first driving unit and rotating the second cylinder about the rotation axis through a second driving unit, whereby the first and second driving units can rotate the first and second cylinders with respective individual directions and velocities.

53. A method as recited in claim 52, wherein inducing a relative rotational movement comprises rotating the inner cylinder and the outer cylinder at respectively angular velocities in a same angular direction.

54. A method as recited in claim 52, wherein inducing a relative rotational movement comprises rotating the inner cylinder and the outer cylinder in opposite angular directions.

55. A method as recited in claim 52, wherein determining an optical property comprises using a camera.

56. A method as recited in claim 55, wherein the camera is a high speed CCD camera.

57. A method as recited in claim 52, wherein the continuous phase is a substance selected from the group consisting of an emulsion, a suspension, a dispersion and combinations thereof.

58. A method as recited in claim 52, wherein the variation of structure comprises a structure variation selected from the group consisting of a deformation of drops of the continuous phase, a rupture of drops of the continuous phase, a coalescence of drops of the continuous phase and combinations thereof.

59. A device as recited in claim 31, wherein the first and second driving units of the rotating mechanism rotate the inner and outer cylinders about the rotation axis in a same direction with a same velocity.
